(19) United States
(12) Patent Application Publication
(10) Pub. No.: US 2017/0119142 A1
(43) Pub. Date: May 4, 2017

(54) PAINT BRUSH

(71) Applicants: Vicki Murphy, Mt. Pleasant, MI (US); Ted Merchand, Winn, MI (US)

(72) Inventors: Vicki Murphy, Mt. Pleasant, MI (US); Ted Merchand, Winn, MI (US)

(21) Appl. No.: 14/929,299

(22) Filed: Oct. 31, 2015

(51) Int. Cl. A46B 5/00; B25G 3/38; B25G 1/06

(52) U.S. Cl. CPC A46B 5/0083; B25G 1/06; B25G 3/38; A46B 5/0095; A46B 2200/202; B05C 17/10

(57) ABSTRACT

A paint brush includes a heel section, a quick disconnect member, and a pivotal section. The quick disconnect member is positioned at one end of the heel section and connects multiple brush cartridges, thereby enabling a user to switch to a different color during a painting operation. The pivotal section is positioned at an opposing end of the heel section, the pivotal section is configured to be mounted on a distal end of an elongate member, where the paint brush is configured to be elevated to a contact surface at a predetermined height, and pivoted at a predefined angle along the pivotal section to paint the contact surface. The quick disconnect member is a snap fit receiver to receive the brush cartridges. The snap fit receiver comprises a push button positioned on the heel section configured to be actuated by a user to connect and disconnect the brush cartridges.

### BACKGROUND

Conventionally, in the painting industry, commercial constructions and other similar buildings present countless challenges in the form of intricate structures and corners to be repaired and painted. Painters, in general, are challenged with a variety of surfaces to be painted which comprise different surface settings and textures, where the painter is supposed to paint such surfaces with paints selected based on different regions to be painted and paint properties, for example, viscosity, the paint color, etc. The painting or coating features are affected by aspects such as temperature, humidity, technique of paint application, brush stroke, design of bristles, etc. Painters are supposed to paint large walls, high ceilings, uneven floors, and angled corners. Most of the times the contact surfaces can be effortlessly contacted, but during certain occasions the contact surfaces for painting might be out of reach and in angled locations.

However, for painters, even with such numerous difficulties and variables that they regularly stumble upon in their work place, they have a comparatively restricted choice of the type and size of brushes that would be suitable for a particular condition. Furthermore restraining are the size of the handles and fixed design of the paint brushes. Although the paint brushes are available in multiple widths, as far as the heel section of the paint brush is concerned, the bristles are fixedly attached to the heel section and is not interchangeable. Each time, the painter needs to reach for a new brush if a change in color or coating is required. In other words, the bristles or bristle cartridges cannot be quickly disconnected to be swapped within another brush cartridge to apply another paint.

Further, the usage of a conventional paint brush is a tedious task involving predominantly the arms and wrists of the painters, and the level of difficulty is even more when the painting surfaces are high and angled. In such cases, the painter is supposed to attach the paint brush to an elongate rod and paint the high surfaces, but again the angled sections to be painted cannot be contacted completely.

Therefore, there is a need for a paint brush which can attach multiple types of brush cartridges, and the handle and head of the brush can be movable sideways and/or movable towards front and back in order to reach angled surfaces and corners.

### SUMMARY OF THE INVENTION

The present invention relates to a paint brush comprising a heel section, a quick disconnect member, and a pivotal section. The quick disconnect member is positioned at one end of the heel section and is configured to connect multiple brush cartridges, thereby enabling a user to switch to a different color during a painting operation. The pivotal section is positioned at an opposing end of the heel section, the pivotal section is configured to be mounted on a distal end of an elongate member, where the paint brush is configured to be elevated to a contact surface at a predetermined height, and pivoted at a predefined angle along the pivotal section to paint the contact surface.

In an embodiment, the quick disconnect member is a snap fit receiver configured to receive the brush cartridges. In an embodiment, the snap fit receiver further comprises a push button positioned on the heel section configured to be actuated by a user to connect and disconnect the brush cartridges. In an embodiment, the pivotal section comprises one or more connecting members pivotally linked to each other at a first joint, and the connecting members pivotally attached to the heel section at a second joint, the first joint and the second joint allows the pivotal section to be swiveled along multiple angles. In an embodiment, the first joint pivotally linking the connecting members is configured to swivel horizontally along the length of the paint brush. In an embodiment, the second joint pivotally linking the connecting members and the heel section is configured to swivel vertically along the length of the paint brush.

### BRIEF DESCRIPTION OF THE DRAWINGS

FIG. 1 exemplarily illustrates a front plan view of the paint brush.

FIG. 2A exemplarily illustrates a side perspective view of the paint brush, showing the swiveling action of the paint brush vertically along the length of the paint brush.

FIG. 2B exemplarily illustrates a side view of the paint brush, showing the forward and backward swiveling action of the paint brush along the length of the paint brush.

### DETAILED DESCRIPTION OF THE INVENTION

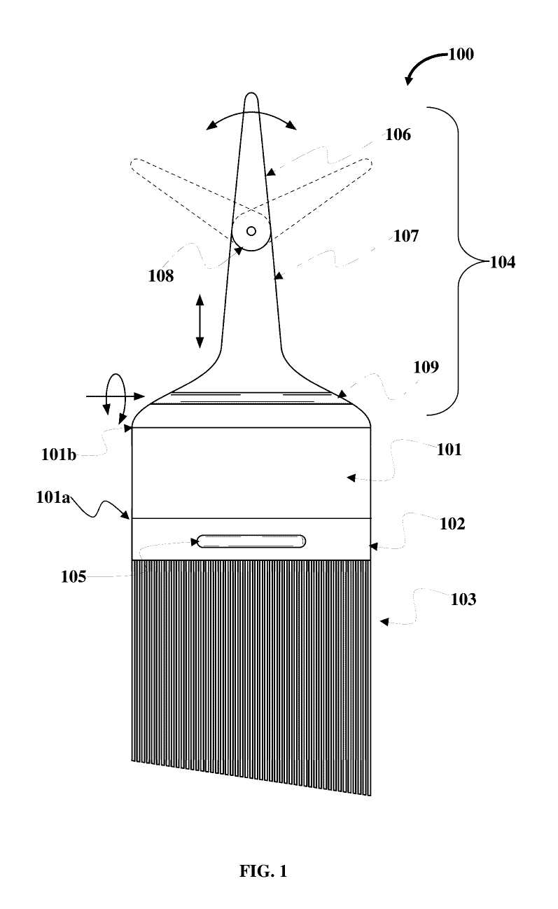

FIG. 1 exemplarily illustrates a front plan view of the paint brush 100. A paint brush 100 comprises a heel section 101, a quick disconnect member 102, and a pivotal section 104. The quick disconnect member 102 is positioned at one end 101a of the heel section 101 and is configured to connect multiple brush cartridges 103, thereby enabling a user to switch to a different color during a painting operation. The user is enabled to connect brush cartridges 103 of different size and shapes which can fit to the quick disconnect member 102 which increases the flexibility of use of the paint brush 100. The primary advantage of the paint brush 100 is that the user can switch to a different color during the painting operation without cleaning the brush cartridges 103, where instead of cleaning the brush cartridges 103, a new brush cartridge 103 is attached after disconnecting the previous brush cartridge 103 to apply a new paint color.

The pivotal section 104 is positioned at an opposing end of the heel section 101, the pivotal section 104 is configured to be mounted on a distal end 101b of an elongate member, where the paint brush 100 is configured to be elevated to a contact surface at a predetermined height, and pivoted at a predefined angle along the pivotal section 104 to paint the contact surface. An ordinary painting brush is therefore modified with the above modifications to form the paint brush 100 so that the modifications will allow the painter to contact the paint brush 100 on higher areas such as ceilings and domes of buildings, and stairwells and high corners with precise angles using the pivotal arrangement of the paint brush 100.

In an embodiment, the quick disconnect member 102 is a snap fit receiver configured to receive the brush cartridges 103. In an embodiment, the snap fit receiver further comprises a push button 105 positioned on the heel section 101 configured to be actuated by a user to connect and disconnect the brush cartridges 103. The user presses the push button 105 to release a previous brush cartridge 103 and to install a new one. In an embodiment, the pivotal section 104 comprises one or more connecting members 106 and 107 pivotally linked to each other at a first joint 108, and the connecting members 106 and 107 pivotally attached to the heel section 101 at a second joint 109, the first joint 108 and the second joint 109 allows the pivotal section 104 to be swiveled along multiple angles. In an embodiment, the first joint 108 pivotally linking the connecting members 106 and 107 is configured to swivel horizontally along the length of the paint brush 100, as shown by the arrow in FIG. 1. In an embodiment, the second joint 109 pivotally linking the connecting members 106 and 107 and the heel section 101 is configured to swivel vertically along the length of the paint brush 100, as shown by the arrow in FIG. 1. The paint brush 100 can be further used in tight sections such as water pipes which are positioned behind toilets, cabinets and shelves etc., where it's practically difficult for a painter to apply the paint or reach with the paint brush 100. Multiple types of brush cartridges can also be used to connect to the quick disconnect member 102 of the paint brush 100, for example, brushes designed for latex and oil.

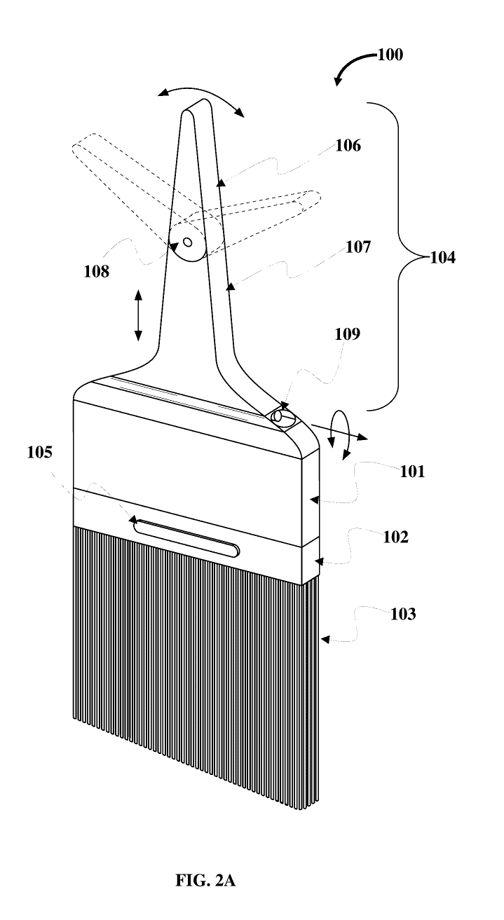

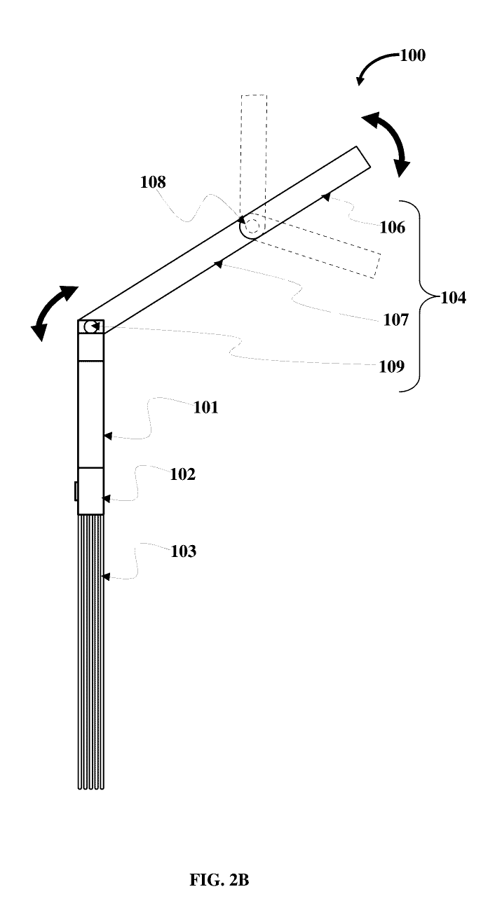

FIG. 2A exemplarily illustrates a side perspective view of the paint brush 100. FIG. 2A further shows the swiveling action of the paint brush 100 vertically along the length of the paint brush 100 at the second joint 109 pivotally linking the connecting members 106 and 107 and the heel section 101, for example, the second joint 109 is formed via a knuckle joint. FIG. 2B exemplarily illustrates a side view of the paint brush 100, showing the forward and backward swiveling action of the paint brush 100 along the length of the paint brush 100, as shown by the arrows in FIG. 2B. Here, in an embodiment, the paint brush 100 is configured to swivel forward and backward along the plane of length of the paint brush 100 at the first joint 108 and the second joint 109.

The pivotal section 104 comprising the connecting members 106 and 107 pivotally linked to each other at a first joint 108, and the connecting members 106 and 107 pivotally attached to the heel section 101 at a second joint 109 which is defined as a handle for the paint brush 100, therefore, during normal operation, the pivotal action of the connecting members 106 and 107 can be locked in a normal manner such as a conventional painting brush by the painter during the painting process. If the painter wants to paint a surface at a precise angle, then the first joint 108 and the second joint 109 can be adjusted and locked at the required angles to paint the surface. Further, the paint brush 100 can be attached to an elongate pole which can be raised to a predetermined height such as ceilings and roofs, where the painter cannot normally access with their hands or via using ladders.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

What is claimed is:

1. A paint brush comprising:
a heel section;
a quick disconnect member positioned at one end of the heel section, the quick disconnect member configured to connect a plurality of brush cartridges, thereby enabling a user to switch to a different color during a painting operation; and
a pivotal section positioned at an opposing end of the heel section, the pivotal section configured to be mounted on a distal end of an elongate member, wherein the paint brush is configured to be elevated to a contact surface at a predetermined height and pivoted at a predefined angle along the pivotal section to paint the contact surface.

2. The paint brush of claim 1, wherein the quick disconnect member is a snap fit receiver configured to receive the brush cartridges.

3. The paint brush of claim 2, wherein the snap fit receiver further comprises a push button positioned on the heel section configured to be actuated by a user to connect and disconnect the brush cartridges.

4. The paint brush of claim 1, wherein the pivotal section comprises one or more connecting members pivotally linked to each other at a first joint, and the connecting members pivotally attached to the heel section at a second joint, wherein the first joint and the second joint allows the pivotal section to be swiveled along multiple angles.

5. The paint brush of claim 4, wherein the first joint pivotally linking the connecting members is configured to swivel horizontally along the length of the paint brush.

6. The paint brush of claim 4, wherein the second joint pivotally linking the connecting members and the heel section is configured to swivel vertically along the length of the paint brush.

7. The paint brush of claim 4, wherein the first joint pivotally linking the connecting members and the heel section is configured to swivel forward and backward along the length of the paint brush.
